(19) United States
(12) Patent Application Publication
(10) Pub. No.: US 2004/0138878 A1
(43) Pub. Date: Jul. 15, 2004

(54) Method for estimating a codec parameter

(76) Inventors: Tim Fingscheidt, Munchen (DE); Jesus Fernando Guitarte Perez, Teruel (ES)

Correspondence Address: BELL, BOYD & LLOYD, LLC, P. O. BOX 1135, CHICAGO, IL, 60690-1135, US

(21) Appl. No.: 10/478,080

(22) PCT Filed: Apr. 26, 2002
(86) PCT No.: PCT/DE02/01546

(30) Foreign Application Priority Data
May 18, 2001 (DE) 101 24 421.5

(51) Int. Cl. G10L 19/10

(52) U.S. Cl. 704/219

(57) ABSTRACT

A method is provided for estimating a codec parameter, wherein the method is particularly applicable to the estimation of filter coefficients in all known forms thereof, from amplification factors and from speech base frequency values such as occur in the coding of speech. Extrapolation, interpolation and linear prediction are used in combination for the estimation.

### DESCRIPTION

The invention relates to a method for estimating a parameter occurring in the course of speech coding, especially a filter coefficient, an amplification factor or a speech base frequency.

In digital communication systems such as the Internet or mobile radio systems, for example GSM or UMTS, source coding methods, for example speech, audio, picture or video coding methods are used to reduce the bit rate to be transmitted. The source coding methods usually deliver a bit stream which is subdivided into frames. In the case of speech transmission in the GSM system a frame of speech-coded bits represents 20 ms of the speech signal. Among other things, the bits within a frame represent a specific set of parameters. These parameters disclose for example the spectral envelope of the speech signal, the speech base frequency or the signal energy or gain respectively.

A frame in its turn is divided into multiple subframes so that some parameters are transmitted once per frame, others once per subframe. In the case of the US-TDMA Enhanced Fullrate (EFR) speech codec with 7.4 kbps a 20 ms frame contains 148 bits. A frame here consists of four subframes. The individual parameters here are as follows:

The 10 coefficients of a filter which represent the spectral envelope of the speech signal in the area of the current frame, are quantized with 26 bits per frame. These coefficients are also referred to as spectral coefficients or spectral parameters.

Using 4×7 bits, four subframes of a excitation signal for this filter are quantized.

2×8 bits and 2×5 bits will be used to represent four values of a speech base frequency.

4×7 bits are used to vector quantize four amplification pairs per frame.

In summary therefore it can be said that the bits within a frame generally represent a specific set of parameters which depend on the source coding method used in each case.

On the send side, redundancy is removed from the digitized signal by what is known as the source coding. On the receive side this is largely reversed by the source decoding, such as the speech decoding.

It can now occur that individual frames or even a number of consecutive frames are lost or are identified in a network component as unusable. These frames, known as bad frames, cannot or should not then be used. The source decoder, for example the speech decoder, must take measures on the receive side to ensure where possible that such a loss of frames does not become audible or, in the case of picture or video transmissions, visible.

In general there is an indicator, called the Bad Frame Indicator (BFI) on the receive side which shows whether a frame was received without errors. BFI=0 below means that the received frame is assumed to be correct, whereas BFI=1 indicates an error, for example that no frame was received at the correct time or that an errored frame was received. Naturally bit errors, meaning the transposition of individual bits within a frame, can occur, depending on system circumstances. These should however furthermore not be subject to different treatment on the receive side or the corresponding frame is identified with BFI=1.

Previously in the case of BFI=1 the current speech signal frame is estimated from the past of the already decoded speech signal by generating a correlation. Alternatively methods are known which estimate the parameters of the current frame from the past of the speech codec parameters and then have the decoders operate in a similar way to the way they would operate if these estimated parameter values were correct. These are as a rule extrapolative methods which only refer back to the bits or parameter values already received.

With speech transmission over the Internet, typically Voice over IP (VoIP), or with speech transmission over the Internet in connection with a mobile communications system (such as for example GSM or UMTS), a buffer is required on the receive side since received packets do not arrive within a fixed time frame, but arrive with different delay times (delay jitter). This type of buffer can where necessary accommodate a number of frames, which means that too frequent losses of frame can be prevented at the expense of an increased transmission delay. However the case also frequently occurs whereby a number of consecutive frames get lost but the frame after the sequence is received correctly. In such cases, when using a buffer, it is advantageous to use an interpolation of the speech codec parameters of the lost frames instead of a conventional extrapolation, since this method is generally more accurate. A simple solution would be a linear interpolation based on the parameter values of the last decoded frame (time t=n−1) and parameter values of the correctly received frame (time t=m>n) over all m-n intermediate lost frames (times t=n, n+1, . . . ,m−1). A buffer and thereby a parameter interpolation can also be implemented with streaming applications since as a rule these are not sensitive as regards the delay time.

The disadvantage in this case however is that there are parameters that cannot be simply interpolated. These often include the amplification factors, the speech base frequency values or even the spectral parameters V_i(t) of a speech frame at point in time t, since they are coded differentially. A spectral parameter V_i(t) of a speech frame in the case of speech coding is for example the filter coefficient of the time-dependent, digital filter with the aid of which the vocal tract is modeled:

Speech is coded for example using the LPC (Linear Predictive Coding) principle. Voiced sounds are generated in this case using a periodic sequence of impulses, voiceless sounds for example using a random noise generator. Plosive sounds are simulated with the aid of a change of amplification and the voice tract with the aid of a variably timed digital filter. The coefficients of this varying digital filter are obtained with the aid of linear prediction, that is a forecast of the following value based on the previous values.

Differential or predictive coding is taken to mean coding of a parameter at a time n, in which values of the parameter at times before point n are also included.

A parameter in the sense of the subsequent embodiments can for example be an amplification factor, a speech base frequency or a spectral parameter. Usual forms of representation of spectral parameters are for example the filter coefficients themselves (in what is known as direct form), auto correlation coefficients, reflection coefficients or log-area ratios. Prior art representations are for example ISF (imittance spectral frequencies), LSF (line spectral frequencies) or LSP (line spectral pairs) respectively. To simplify matters a parameter is assumed below to be a spectral coefficient without restricting its general applicability.

Differential coding and decoding of parameter V_i(t) can for example be undertaken in the following way: On the send side a difference signal X_i(t=n) is determined in accordance with:

X_{—}i(n)=V_{—}i(n)−a_{—}i*Q[X_{—}i(n−1)],i=1,2, . . . ,10, (1)

with V_i(n) being the parameter to be coded, a_i a prediction coefficient, and Q[X_i(n−1)] the quantized difference signal which has been determined for the coding of V_i(n−1) in the previous frame. What is known as vector quantizing is often used for quantizing. This is taken to mean the common quantizing of a number of X_i(n) for specific values of i. A vector quantizing can also mean the common quantizing of two or more different parameter types occurring in a speech coding method. In the case described a vector quantizing could appear as follows: i=1,2,3, and i=4,5,6 and i=7,8,9,10. The quantized difference signal Q[X_i(n)], i=1,2, . . . ,10 is thus represented by a number of bits, for example 26 bits per frame, and transmitted. It can be seen from equation (1) that this type of coding leads to data compression: The memory overhead for the difference values X_i, which represent the difference between almost equivalent size numbers is less than for the values of V_i.

On the receive side a quantized value W_i(n) of spectral parameter V_i(n) is reconstructed from the difference signal value actually received Q[X_i(n)] and the one previously received Q[X_i(n−1)]:

W_{—}i(n)=a_{—}i*Q[X_{—}i(n−1)]+Q[X_{—}i(n)],i=1,2, . . . ,10 (2)

The form of parameter decoding described here is normal in many currently used source coding methods, including for example AMR and EFR speech coders(adaptive multi-rate or enhanced full-rate respectively). In principle of course higher orders of prediction are also conceivable. Usually the rules specified in the equations (1), (2) are executed for the parameter value reduced by the average value. The average value is added in again at the end as the addition of a constant.

A predictive coding, as shown in the example above, has disadvantages for an interpolative determination of a spectral coefficients of missing frames; With a predict quantizing of the first order (see equations (1) and (2)) it is necessary, for an interpolative determination of the quantized parameter value W_i(n) for two consecutive values of the quantized difference signal (Q[X_i(m)], Q[X_i(m+1)]} to be received, which is often precisely not the case with packet switched methods of transmission This state of affairs is illustrated in somewhat greater detail below; for this purpose the quantized difference signal Q[X_i(n)] is represented below as variable Y_i(n): Thus the following applies:

W₁₃ i(n)=a_{—}i*Y_{—}i(n−1)+Y_{—}i(n),i=1,2, . . . ,10. (3)

Assuming below that the last, frame just decoded in accordance with equation (3) belongs to point in time t=n−1 and that currently the frame t=n is to be decoded but BFI(n)=1 applies, indicating the presence of a “bad” frame. Assuming frame t=m>n the first frame after t=n−1, for which BFI=0 applies. The spectral coefficients of all other m-n intervening frames with BFI=1 are now to be interpolated. Spectral coefficient W_i(n−1) now forms the lower (that is located in the past) support point of the interpolation. Spectral coefficient W_i(m) should normally form the upper (that is located in the future) support point of the interpolation. With predictive coding however it cannot be computed since for equation (3), although the variable Y_i(m) was received, required variable Y_i(m−1) is missing. Only after two consecutive correctly received frames m and m+l could a spectral coefficient W_i(m+1)=a_i* Y_i(m)+Y_i(m+1) be computed and serve as a support point for an interpolation on the receive side. In principle however this demands an additional delay of one frame, which represents a significant problem at least for bidirectional speech transmission, or two consecutive frames with BFI=0, which is not always available, especially with packet-switched transmission modes.

With Lth-order prediction the problem is correspondingly exacerbated with the above aspects: Differential decoding according to equation (2) requires L+1 consecutive variables or difference signals Y_i(t), meaning that for interpolation of the spectral coefficients of preceding frames with BFI=1 a number L+1 of consecutive correct frames must be received to again obtain in the last of these frames a completely error-free set of spectral coefficients and thereby an upper support point for interpolation.

Even if in widely-used speech coding methods linear prediction with L=1 is often chosen for reasons of error propagation, it can be said in summary that two consecutive correct frames must still be received before a correct spectral coefficient W_i(m+1) is received again. Viewed statistically this is naturally less likely than receiving one correct frame. This fact results as a rule in longer delay times, which is not tolerable for real time-sensitive applications.

The underlying object of the present invention is thus to specify a method with which codec parameters can be identified on the receive side, even if the underlying data is missing from individual or from a number of consecutive time ranges.

This object is achieved by the independent claims 1 and 2. Further developments emerge from the dependent claims.

The invention relates to a method of receive-side estimation of a variably—timed parameter at an nth point in time. The parameter has been predictively coded on the send side and will be determined interpolatively on the receive side, depending on at least two variables. One support point of the interpolation, the first variable, is formed by an earlier value of the parameter which has already been decoded, a second support point of the interpolation, the second variable, is determined by extrapolative measures. The interpolative determination of the parameter can be undertaken by means of known interpolation measures, for example by means of linear interpolation between first and second variable. With one variant of the embodiment weighted summation is also used for interpolation.

The advantage of this method is that an interpolation can be undertaken to determine the parameter as soon as the second variable is known.

The invention further relates to a method for receive-side estimation of a codec parameter assigned to an nth frame. The codec parameter is predictively coded on the send side and will be determined on the receive side as a function of at least two signals by interpolation. One support point of the interpolation will be formed by the previously decoded parameters of the (n−1)th frame, a further support point will be formed by the parameters of the mth frame with m>n, which was determined by extrapolative means.

One development consists of an interpolation being undertaken as soon as the data of a correct frame is present. This has the advantage of short delay time with simultaneous use of an interpolative means for parameter estimation.

Another development makes provision for the quality of reception to be shown by an indicator variable. This Indicator variable can for example be the Bad Frame Indicator BFI. The invention is explained in more detail below using a number of exemplary embodiments

In addition

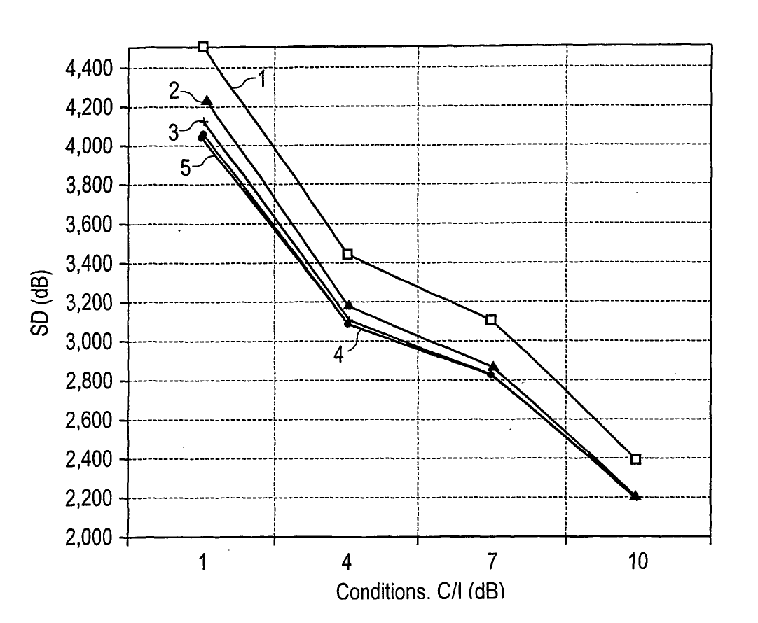

FIG. 1 shows the simulation results of a GSM full-rate channel transmission with the results of various methods of extrapolation being shown.

In a possible embodiment the differentially coded parameters are subjected to a process consisting of two steps: Initially the parameters of the frame for which a Bad Frame Indicator, BFI=1, is present, are estimated extrapolatively. The first frame correctly received again can now be decoded on this basis. It then forms the basis for an interpolative re estimation of the parameters of the preceding frame with BFI=1.

For each received frame with BFI=1, that is a frame which is present and is not correct, there is provision for first undertaking a conventional extrapolation of the parameters. This comprises (at least in the last frame with BFI=0.1 before a frame with BFI=0) for differentially coded parameters a computation of the quantized difference signals or the variable Y “afterwards”. In the example specified at the start, this conventional method, after extrapolative determination of W_i(n) in frame t=n according to equation (3) provides for variable Y-i(n) to be determined by converting equation (3)

Y_{—}i(n)=W_{—}i(n)−a₁₃ i*Y_{—}i(n−1),i=1,2, . . . 10, (4)

This means that at time t=n+1 a difference signal of the preceding frame, i.e. Y_i(n), is again present, so that it can be decoded at any time again using equation (3). Through the (preliminary) extrapolative method an upper support point W_i(m) can thus be determined, if m BFI(m)=0 only applies for the frame. No further correct frame is required. The interpolation of the m-nth frame back can occur directly at point t=m.

On account of the memory of the differential coding support point W_i(m) is susceptible to errors. These errors only disappear completely only on reception of L consecutive frames with BFI=0. Separate simulations to test this method show however that W_i(m) can be used as upper support point to allow a significantly better approximation of the parameters compared to the prior art. The major advantage of this method is that an error burst, meaning a sequence of m-n bad frames, can be interpolated by waiting for a single correct frame and that this can be done even if differentially coded parameters are present. No additional delay is needed; In addition the statistically more rare case of L consecutive frames with BFI=0 is not a precondition.

A first exemplary embodiment will now consider differentially coded parameters, with a first-order prediction, i.e. L=1:

This makes the following assumptions:

The spectral coefficient W_i(n−1) is already decoded-Y-i(n−1) is present either received [BFI(n−1)=0] or reconstructed according to equation (4) [BFI(n−1)=1].

as a result of the recursive algorithm given below, Y_i(n), . . . ,Y_i(n+K−1) are also available.

Let the current time be t=n+K, at this point the spectral coefficient W_i(n) is to be determined.

This therefore means that a time delay of K frames is allowed for interpolation.

The process is now undertaken in two steps: a) Operations at frame n+K:

If BFI(n+K)=0: Compute W_i(n+K) according to equation (3). If BFI(n+K)=1: Compute a provisional extrapolated version W_i(n+K) with any extrapolative method.

b) Decode frame n:

If BFI(n)=0: Compute W_i(n) according to equation (3). If BFI(n)=1: Compute m>n, where m is the first frame with BFI(m)=0 after frame n.

If m>n+K: Compute with any extrapolation method W_i(n).

If m<=n+K: Then for frame m as a correctly received frame there is already a provisionally extrapolatively determined spectral coefficient value W_i(m) available. It forms the upper (or future) support point for an interpolation of parameter W_i(n). Let the lower (or past) support point be spectral coefficient W_i(n−1). Now for example a linear interpolation can be performed. This is done by taking account of the timing gaps between frame n and the support points: [W_i(n)=[W_i(n−1)-W_i(m)]*(m-n)/(m-n+1)+W_i(m). The upper support point W_i(m) is already provisionally determined extrapolatively, the lower support point W-i(n−1) is already finally decoded.

FIG. 1 shows a simulation of a GSM full-rate channel transmission with various C/I (carrier-to-interferer) ratios, which describe the channel quality. For the curves the spectral distortion (SD), a usual measure of quality for coding or transmission respectively of spectral coefficients, is plotted against the C/I ratio. The higher the SD, the worse the receive-side speech quality.

Curve 1 shows an extrapolation as used in the previous decoding methods. Curves 2 through 5 show the results for the above exemplary embodiment depending on variable K which specifies the maximum allowed time delay in frames. In this case curve 2 features a delay by one frame (K=1), curve 3 a delay by two frames (K=2), curve 4 a delay by three frames (K=3) and curve 5 a delay by four frames (K=4).

It can be seen that even with a delay of a single frame (K=1) an enormous gain can be achieved, more than K=2 future frames bring no great additional gain. These simulation results are extremely advantageous for the transmission of real-time-sensitive applications since only a slight delay is allowed here. With very low C/I ratios however slight differences can be seen for different delay values (K=1,2,3,4). The reason for this is that with this type of bad C/I ratio a number of consecutive frames are frequently bad frames.

As well as the examples given above there are a large number of embodiment variants within the context of the invention which will not be further described here. They can however be implemented in practice on the basis of the previous examples without any great effort by the person skilled in the art.

1. Method for receive-side estimation of the value of a temporally variable parameter at an nth point in time,
with the parameter being predictively coded on the send side,
with which the parameter on the receive will be determined as a function of at least two variables, characterized in that
the parameters on the receive side are determined interpolatively,
with the value of the decoded parameter which is assigned to a point earlier than the nth point representing the first value which forms a support point of the interpolation, and
a second value determined by extrapolative means, which is assigned to a point in time after the nth point, forming a further support point of the interpolation.

2. Method for receive-side estimation of a codec parameter assigned to an nth frame,
for which the codec parameter on the send side is predictively coded,
for which the codec parameter on the receive side is determined as a function of at least two variables, characterized in that
the codec parameter is determined interpolatively, with the codec parameter of the (n−1) th frame previously decoded forming a support point of the interpolation and the first value,
and a parameter of an mth frame, determined by extrapolative means, with m>n, forming another support point of the interpolation and the second variable.

3. Method according to one of the previous claims, with which an interpolation is performed as soon as the data is received for only one correct frame.

4. Method in accordance with one of the previous claims, with which the quality of the reception is shown by an indicator variable.
